(19) United States
(12) Patent Application Publication
(10) Pub. No.: US 2011/0033625 A1
(43) Pub. Date: Feb. 10, 2011

(54) USE OF FLEXIBLE SEALING SLURRIES FOR THE AFTERTREATMENT OF FRESH CONCRETE SLABS

(75) Inventor: Josef Weichmann, Pleiskirchen (DE)

Correspondence Address: FULBRIGHT & JAWORSKI, LLP, 666 FIFTH AVE, NEW YORK, NY, 10103-3198, US

(73) Assignee: CONSTRUCTION RESEARCH & TECHNOLOGY GMBH, Trostberg (DE)

(21) Appl. No.: 12/936,937

(22) PCT Filed: Apr. 17, 2009
(86) PCT No.: PCT/EP2009/054572

§ 371 Date: Oct. 15, 2010

(30) Foreign Application Priority Data
Apr. 29, 2008 (DE) 10 2008 021 451.5

(51) Int. Cl. B05D 3/00

(52) U.S. Cl. 427/331

(57) ABSTRACT

The use of a slurry-type seal coating which is flexible after hardening, containing, as component a), a system having a proportion of hydraulic binder and, as component b), an elastifying plastic, for aftertreatment, over the whole area, of a concrete body having a residual moisture content >2 CM % is claimed. The claimed slurry-type seal coatings which contain, as component a), preferably a cement mortar and, as component b), a homo-, co- or terpolymer in the preferred form of a liquid polymer dispersion result in a higher strength and less shrinkage of the concrete body surface treated with them. The concrete bodies treated therewith are protected against seepage water, pressurised water and water splashes, in particular in areas exposed to wetness.

The present invention relates to the use of a slurry-type seal coating which is flexible after hardening for the aftertreatment of a concrete body.

The use of flexible slurry-type seal coatings is well known in the construction industry. The requirements which suitable products have to meet in this context are described, for example, in “Richtlinien für die Planung und Ausführung von Abdichtungen, erdberührter Bauteile mit flexiblen Dichtungsschlämmen” [Guidelines for the planning and implementation of sealing of components in contact with earth using flexible slurry-type seal coatings] of Deutsche Bauchemie e.V. Furthermore, flexible slurry-type seal coatings are used for laying tiles and slabs on balconies and terraces. Here, the slurry-type seal coating is applied directly to the concrete surface and a covering of tiles and slabs is then laid thereon.

In the general sense, slurry-type seal coatings are used in the building industry for sealing and for protecting surfaces present underneath, such as, for example, masonry, but in particular also concrete bodies and screeds, from penetrating water. The PCI Seccoral® 1K and 2K product series from PCI Augsburg GmbH may be mentioned here by way of example. These Seccoral products serve primarily for crack-bridging sealing under ceramic coverings on balconies, terraces and shower systems, said products being fine cement mortars with proportions of elastifying plastic. The products are applied in a dry layer thickness of at least 2 mm. In another variant, the Seccoral products are used for sealing outer walls of cellars, but also foundations. Furthermore, they serve in particular for crack-bridging sealing of ceramic coverings in showers and rooms with floor drains, swimming pools, health spas and saline spas up to a head of water of 15 m and in particular against pressurised water from inside.

The application of flexible slurry-type seal coatings is effected according to the prior art on surfaces ready for coating. If these are a concrete body and here as a rule cement screeds, the expression “ready for coating” means that the concrete body should have a residual moisture content of an average <2 CM %.

The CM measurement is suitable for determining the moisture content of mineral building materials. The method of measurement can be carried out in an entirely uncomplicated manner on site and gives reliable results. Since a sample must be taken for the measurement, the CM method is a “destructive” method. Depending on the presumed moisture, the measuring sample of about 10 to 50 g is taken from the mineral component to be tested. After accurate weighing of the sample, the latter is pulverized and is mixed by vigorous shaking in a steel cylinder with manometer with addition of 4 steel balls and with an ampoule of calcium carbide. Acetylene gas is liberated by the chemical reaction of the calcium carbide with water which now takes place. After about 15 min, a constant gas pressure results, with the aid of which and taking into account the amount of sample taken, the water content of the sample can be determined directly on the manometer or by calculation and reading off in a table. Because the test material is taken selectively, it is also possible to investigate individual component layers, for example plastered walls, with regard to their moisture content.

Alternatively, the duration of hardening is also used as a criterion of the readiness for coating. Thus, in DIN 18 157, the required time span between freshly introduced underlayment and covering with tiles and slabs is defined. A time span of 6 months should be observed for laying with cementitious tile adhesives on concrete bases and of 28 days for laying of tiles and slabs with cementitious tile adhesives on cement screeds. The waiting times and the length thereof are however generally dependent on various factors, such as the thickness of the concrete body, the w/c (water/cement) value of the concrete body, the atmospheric humidity and temperature, etc. Further details on readiness for coating can also be found in the best practice guide on assessment and preparation of surface issued by the German National Screed and Coatings Association [BEB-Merkblatt “Beurteilen und Vorbereiten von Untergründen”] and in DIN 18560 Part I “Screeds in the building industry—definitions, general requirements, testing”.

The material composition of flexible slurry-type seal coatings usually used is described, for example, in the publications EP 1 306 357 A1, DE 100 37 951 and DE 198 29 537. The binder system consists of cement and a liquid aqueous polymer dispersion in the case of two-part systems and of cement and a polymer dispersion powder in the case of one-part systems. A plastic/cement ratio of >0.6 is required in order that the required flexibility is actually achieved. The flexibility of slurry-type seal coatings serves for bridging potential surface cracks in the concrete body. This means that the watertightness achieved by the slurry-type seal coatings cannot be impaired by the formation of cracks or be lost. This is the difference between flexible slurry-type seal coatings and conventional rigid mineral slurry-type seal coatings.

The aftertreatment of concrete bodies serves for improving the properties of the treated body, which is generally a cement screed or another base. In particular, the strength development, the shrinkage behaviour and the tendency to cracking of the bodies treated therewith are improved. The aftertreatment can be effected according to the prior art with the aid of a very wide range of methods:

Thus, for example, so-called curing agents or else films can be applied. Thus, for example, DE-A 2 042 735 describes a plastic film which serves for sealing purposes on structures and has ribs projecting from the film on one side. This plastic film which can be used as concreting film or the like is in the form of a corrugated film, the ribs projecting on one side being designed as corrugated ribs continuing uninterruptedly in the longitudinal direction of the film and, in plan view, substantially meandering. CH 630 984 describes a film which is folded for the formation of anchoring projections and which is sunk into the concrete which has not yet hardened. This insulating cladding, which is applied in particular on interior room walls, has fastening ribs which run on its back and are spaced apart. The cladding preferably consists of an elastic film in which the fastening ribs and the joints are formed by folding. In this way, the insulating cladding can be stretched to the desired covering length transversely to its ribs when it is fastened on the wall.

Particular attention should be paid to DE-A 103 43 970 A1. A method for the treatment of a concrete body for protection from evaporation of water not immediately bound is described. The treatment is effected with the aid of a special sheet material which is applied to the no longer completely fresh concrete body and is firmly bonded to it. This is effected by pressing the sheet material, which may be a film, with one surface which has structural parts into the concrete body. The point of the method described for the aftertreatment of fresh concrete is that concrete components develop shrinkage phenomena due to drying out through the concrete surface and thus become deformed. These deformations can subsequently cause fracture of the concrete component and cracking and subsequently static failure and the penetration of moisture. The drying out and the shrinkage phenomena are said to be prevented by the application of the sheet material.

A disadvantage in the case of the known method for the aftertreatment of concretes by curing agents is that, owing to the generally poor adhesion properties of the surfaces, said curing agents cannot remain permanently on the treated base. Thus, for example, no further coverings or surface finishes in the form of renders can be applied or tiles and slabs laid. Such additional surface finishes can, however, provide reliable and permanent sealing of the structural body against penetrating water, which, however, is ruled out owing to the disadvantages of the curing agents described.

A disadvantage of the use of conventional film materials used for aftertreatment is that they also do not remain permanently bonded to the base. Rather, after curing of the concrete body, they must as a rule be removed again. Moreover, the application of a subsequent surface coating is not possible owing to the material properties of the film materials. Regarding the sheet material to be used according to DE 103 453 979, it is considered to be difficult to process since it is essential to implement an adhesive bond to the concrete body, which represents an additional operation. Moreover, the sheet material must, if required, be adapted to the structures of the concrete body, for example by cutting. If tiles and slabs are finally applied to the sheet material described, an additional adhesive bonding step must follow.

On the basis of the prior art described, the object of the present invention is to provide a suitable novel system for the aftertreatment of a concrete body having a defined residual moisture content. The suitable system should be economical. The primary aim was in particular to reliably prevent the penetration of water from outer regions into a concrete body. Moreover, after the system has been used according to the invention, a subsequent rigid surface coating, such as, for example, by tile and slab coverings, should be possible within as short a period as possible after completion of the concrete body.

This object was achieved by the use of a slurry-type seal coating which is flexible after hardening, containing, as component a), a system having a proportion of hydraulic binder and, as component b), an elastifying plastic, for aftertreatment, over the whole area, of a concrete body having a residual moisture content >2 CM %.

It has surprisingly been found that not only could the object be completely achieved by the use according to the invention but that additionally decoupling of the still shrinking base with a rigid coating in the form of tiles or slabs is ensured by the use of the flexible slurry-type seal coating.

The advantages were not foreseeable to this extent.

In the context of the present invention, the expression “elastifying” is understood as meaning the plasto-elastic behaviour of the plastic component. This can subsequently deform on application of tensile forces, which generally manifests itself in extension behaviour. Once the force is no longer applied, however, the plastic does not return completely to its initial form and instead a slight deformation persists.

The present use prefers a variant in which the slurry-type seal coating contains, as component a), a mortar, preferably a cement mortar and in particular a fine cement mortar. According to the invention, the cement component may be a Portland cement, a high-alumina cement or mixtures thereof.

The present invention also comprises a variant in which the slurry-type seal coating contains, as component b), at least one representative of the series consisting of homo-, co- or terpolymer based on styrene, butadiene, vinyl acetate, vinyl propionate, vinyl laurate, vinyl versatate, vinyl chloride, vinylidene chloride, ethylene, acrylates and mixtures thereof.

Preferably, the flexible slurry-type seal coating should have two components, the components a) and b) being present separately. The property of the two-component character is therefore based primarily on the two components a) and b) of the slurry-type seal coating.

The claimed flexible slurry-type seal coating develops its positive properties particularly when component b) is a liquid polymer dispersion having a preferred proportion of polymer of not more than 60% by weight. The proportion of polymer should not fall below 20% by weight and should preferably be between 25 and 50% by weight, values of 30, 40 and 45% by weight being regarded as being particularly preferred.

The plastic/cement (p/c) ratio of component b) to component a) should be between 0.5 and 2.0. A range between 0.7 and 1.4 is to be regarded as being preferred. In addition to the described components a) and b), the flexible slurry-type seal coating according to the invention may additionally contain at least one representative selected from the series consisting of fillers, aggregates, pigments, superplasticizers, thickeners, rheological auxiliaries, setting accelerators, setting retardants, antifoamer, wetting agents, dispersants, plasticizers, coalescents and surfactants. Suitable specific representatives here are in particular silicates and carbonates having a particle size of 0.06 mm to 0.5 mm as fillers, pigments based on titanium dioxide or iron hydroxide, rheological auxiliaries, such as starch ethers, cellulose fibres, polyacrylamides, phyllosilicates, setting accelerators, such as lithium carbonate, calcium carbonate, calcium nitrate, calcium formate, setting retardants, such as alkali metal pyrophosphates, complex phosphates, boron salts or calcium sulphates, sucroses, glucoses, fructoses, malic acids, gallic acid, gluconic acids, tartaric acids and citric acids and salts thereof.

The flexible slurry-type seal coatings according to the invention develop their advantageous properties in particular on concrete bodies which have a residual moisture content of >4 CM %. In principle, the claimed use is not limited to certain concrete bodies. However, the application to cement screeds or to balcony and terrace bases has proved to be particularly suitable. The base should be capable of being walked on in general form, i.e. should have a load capacity up to a certain weight limit.

The flexible slurry-type seal coating is usually applied with the aid of, for example, smoothing trowels or notched trowels to the concrete body to be aftertreated. The layer thickness should reach a minimum layer thickness. This is understood by the present invention as being a wet layer thickness of the slurry-type seal coating of ≧1.0 mm, preferably ≧1.5 mm and particularly preferably ≧2.0 mm. The concrete body may be a cement screed and in particular a screed on a separating course or a screed on an insulating layer. Screeds on a separating course are applied to an adhesion-preventing layer, the so-called separating layer, to, for example, bituminous sheet or boards or plastic films, on the supporting concrete body as a base. This prevents horizontal force transmission of the screed on the concrete body. The separating layer is as a rule in the form of a moisture or vapour barrier. Screeds on an insulating layer, i.e. so-called floating screeds, are applied on an insulating layer.

In accordance with the use according to the invention, the flexible slurry-type seal coating should, after their application, cover the surface of the concrete body continuously to an extent of ≧80%, preferably to an extent of ≧90% and particularly preferably to an extent of ≧95%.

Finally, the present invention also takes into account that the slurry-type seal coating applied on the concrete body is provided with a rigid layer and preferably with tiles and slabs. The rigid layer mentioned can be applied to the slurry-type seal coating which has not yet set. As a rule, however, the subsequent covering is applied after hardening of the slurry-type seal coating. A covering comprising tiles and slabs is laid using a conventional tile adhesive.

The aftertreatment in a region subject to wetting and preferably against seepage water, against pressurised water and water splashes has proved to be a particular use variant of the present invention.

Surprisingly, it has been found with the use according to the invention that an aftertreatment of the concrete body is achieved simply by applying the water vapour-permeable and flexible slurry-type seal coating. In fact, the concrete body treated with the slurry-type seal coating shows a higher strength and also less shrinkage in its totality. This makes it particularly suitable for the final application of a rigid surface layer which can be applied directly into not set fresh bed of the slurry-type seal coating, and it is for this reason that additional operations are dispensed with. However, it is also possible to allow the flexible slurry-type seal coating first to harden and then to provide it with a rigid covering, which is effected by the additional application of an adhesive layer.

The advantage of the use according to the invention is clear in particular when laying tiles and slabs since a simultaneous aftertreatment of the concrete body, adhesive bonding of the slab covering, sealing against penetrating or rising water and decoupling of the base from the rigid coating are achieved thereby. The use according to the invention is very particularly advantageous on cement screeds. Here, deformation of the screed is prevented by decoupling of the screed from the rigid top covering. A deformation occurs when a rigid top covering is applied to a screed which has not yet hardened. Shrinkage-related shortening of the screed and of the shrinkage-preventing top covering results in the shortening of the screed region facing away from the top covering. The screed shows a convex deformation or bulging, which can lead to damage.

The following examples demonstrate the advantages of the present invention.

### EXAMPLES

### Example 1

For the following working example, the product PCI Seccoral® 2K from PCI Augsburg GmbH was used. This product is a two-component composition consisting of a modified acrylate dispersion as a liquid component and a special cement mortar with sealing plastics as a powder component.

First, a cement screed (4 cm layer thickness) was applied to a separating course. The area was 2×2 m; the insulation consisted of 3 cm thick Styropor® sheets which were covered with PE film. Edge insulating strips were applied to the edges. As soon as the screed could be walked on, after about 12 hours, the slurry-type seal coating was applied according to the manufacturer's instructions to said screed by means of a notched trowel and smoothing trowel in a wet layer thickness of 3 mm. The area thus applied had hardened after a further 16 hours and was fully capable of being walked on.

Simultaneously and in the same manner, a cement screed was introduced which, however, was not subjected to an aftertreatment. This screed, in contrast to the screed treated with PCI Seccoral® as a slurry-type seal coating, showed cracks and also keying (concave arching) after 2 months. The latter effect is understood as meaning that corner and edge regions of the screed bulge relative to the centre of the screed surface. This occurs especially because screeds on a separating course shrink to a lesser extent on their side facing the separating course, owing to reduced or suppressed exit of water there, than the top side of the screed which faces away from the separating course. The shrinkage of the top side results in a reduction in length in relation to the bottom side and hence in keying. The keying was detected by placing a measuring rod over the total screed surface.

### Example 2

First, a cement screed (4 cm layer thickness) was applied to a separating course. The area was 2×2 m; the insulation consisted of 3 cm thick Styropor® sheets which were covered with PE film. Edge insulating strips were applied to the edges. As soon as the screed could be walked on, after about 12 hours, the slurry-type seal coating was applied according to the manufacturer's instructions to said screed by means of a notched trowel and smoothing trowel in a wet layer thickness of 3 mm. The area thus applied had hardened after a further 16 hours and was capable of being walked on. After these 16 h, a top covering consisting of 60×60 cm fully vitrified tiles was laid using a conventional tile adhesive (PCI FT adhesive mortar). A further 16 h later, the joints (joint width 3 mm) were closed with joint mortar.

Concurrently and in the same manner, a screed was introduced which, however, was not subjected to an aftertreatment with flexible slurry-type seal coating. The covering consisting of fully vitrified tiles laid as described above and was jointed.

After 6 months, the screed surface without the aftertreatment with slurry-type seal coating showed a bulge in the centre of the screed (convex arching). In the case of individual tiles, detachment (especially in the middle region of the screed surface) and cracking occurred. The bulging is caused because the cement screed shrinks in the course of its hardening (water loss but especially chemical shrinkage). The shrinkage on the screed surface facing the tile covering is prevented by the adhesive bond between the screed and the rigid and non-shrinking surface covering of fully vitrified tiles. The shortening of the screed is therefore less on the surface than on the screed bottom facing away from the surface. Bulging of the screed occurs, i.e. the centre of the screed is higher in comparison with the corner and edge region.

In the case of the screed body provided with slurry-type seal coating, no convex arching was observable. Detachment of tiles and cracking also did not occur.

1-16. (canceled)

17. A method for applying a slurry-type seal coating to a surface of a concrete body, comprising:
applying to said concrete surface a slurry-type seal coating mixture; and
hardening the applied mixture to form a slurry-type seal coating on the surface of the concrete body;
wherein the slurry-type seal coating mixture comprises
component a) which is a system comprising a hydraulic binder; and
component b) which is an elastifying plastic, for aftertreatment, over the surface of the concrete body having a residual moisture content >2 CM %; and wherein the slurry-type seal coating is flexible after hardening.

18. The method according to claim 17, wherein the hydraulic binder is a mortar.

19. The method according to claim 18, wherein the mortar is a cement mortar.

20. The method of claim 19, wherein the cement mortar is a fine cement mortar.

21. The method according to claim 17, wherein the slurry-type seal coating comprises the components a) and b) separately from each other.

22. The method according to claim 21, wherein the component b) is a liquid polymer dispersion having a polymer content of not more than 60% by weight.

23. The method according to claim 17, wherein the plastic/cement (p/c) ratio of component b) to component a) is between 0.5 and 2.0.

24. The method according to claim 17, wherein the slurry-type seal coating further comprises at least one member selected from the group consisting of a filler, an aggregate, a pigment, a superplasticizer, a thickener, a rheological auxiliary, a setting accelerator, a setting retardant, an antifoamer, a wetting agent, a dispersant, a plasticizer, a coalescent and a surfactant.

25. The method according to claim 17, wherein the concrete body has a residual moisture content of >4 CM %.

26. The method according to claim 17, wherein the concrete body is a cement screed or a cantilever balcony or terrace slab.

27. The method according to claim 17, wherein the slurry-type seal coating is applied in a wet layer thickness of ≧1 mm to the concrete body.

28. The method according to claim 17, wherein the slurry-type seal coat covers the surface of the concrete body to an extent of ≧80%.

29. The method according to claim 17, wherein the slurry-type seal coating applied to the concrete body is provided with a rigid layer.

30. The method according to claim 28, wherein the rigid layer is applied to the slurry-type seal coating which has not yet hardened.

31. The method according to claim 29, wherein the rigid layer is applied to the slurry-type seal coating which has not yet hardened.

32. The method according to claim 30, wherein a sheet-like elastic element is applied to the slurry-type seal coating which has not yet set and is pressed into the slurry-type seal coating.

33. The method according to claim 32, wherein a sheet-like elastic element is applied to the slurry-type seal coating which has not yet set and in particular is pressed into it.

34. The method according to claim 17, wherein the mixture is applied to the surface of the concrete body as an aftertreatment in areas of the concrete surface exposed to wetness.

35. The method according to claim 18, wherein the cement component is a Portland cement, a high-alumina cement or mixtures thereof.

36. The method according to claim 17, wherein component b) contains at least one member selected from the group consisting of a homopolymer based on styrene, a homopolymer based on butadiene, a homopolymer based on vinyl acetate, a homopolymer based on vinyl versatate, a homopolymer based on vinyl chloride, a homopolymer based on vinylidene chloride, a homopolymer based on ethylene, a homopolymer based on acrylate, a copolymer based on styrene, a copolymer based on butadiene, a copolymer based on vinyl acetate, a copolymer based on vinyl versatate, a copolymer based on vinyl chloride, a copolymer based on vinylidene chloride, a copolymer based on ethylene, a copolymer based on acrylate, a terpolymer based on styrene, a terpolymer based on butadiene, a terpolymer based on vinyl acetate, a terpolymer based on vinyl versatate, a terpolymer based on vinyl chloride, a terpolymer based on vinylidene chloride, a terpolymer based on ethylene and a terpolymer based on acrylate.

37. The method according to claim 17, wherein the plastic/cement (p/c) ratio of component b) to component a) is between 0.7 and 1.8.

38. The method according to claim 17, wherein the slurry-type seal coating is applied in a wet layer thickness of ≧1.5 mm to the concrete surface.

39. The method according to claim 17, wherein the slurry-type seal coating is applied in a wet layer thickness of ≧2 mm to the concrete body.

40. The method according to claim 17, wherein the slurry-type seal coat covers the surface of the concrete body to an extent of ≧90%.

41. The method according to claim 17, wherein the slurry-type seal coat covers the surface of the concrete body to an extent of >95%.

42. The method according to claim 32, wherein the sheet-like elastic element is in the form of a nonwoven, a mesh, a woven fabric or a film.

43. The method according to claim 33, wherein the sheet-like elastic element is in the form of a nonwoven, a mesh, a woven fabric or a film.
